(19) United States
(12) Patent Application Publication
(10) Pub. No.: US 2008/0004914 A1
(43) Pub. Date: Jan. 3, 2008

(54) COMPUTERIZED METHOD FOR COMPILING MEDICAL DATA SETS FOR PRESENTATION

(76) Inventor: Jan Schreiber, Erlangen (DE)

Correspondence Address: SCHIFF HARDIN, LLP;PATENT DEPARTMENT, 6600 SEARS TOWER, CHICAGO, IL, 60606-6473, US

(21) Appl. No.: 11/763,572

(22) Filed: Jun. 15, 2007

(30) Foreign Application Priority Data
Jun. 30, 2006 (DE) 10 2006 030 274.5

(51) Int. Cl. G06Q 50/00

(52) U.S. Cl. 705/3

(57) ABSTRACT

A computerized method for composition of medical data sets for presentation to at least one panel of medical specialists uses a rule-based system for efficient composition of the medical data set. The use of a rule-based system for automatic generation of presentation documents for a medical panel unburdens medical personnel from the (in part) manual composition of the presentation documents, and a more effective workflow of the diagnostic processing in the framework of a presentation to a medical panel is therewith enabled.

### BACKGROUND OF THE INVENTION

1. Field of the Invention

The present n concerns a computerized method for compiling medical data sets for presentation to a panel of medical practitioners, such as medical specialists, as well as a rule-based system for efficiently compiling a medical data set.

2. Description of the Prior Art

Workflows in a hospital place highly complex demands on specialized personnel, so the workflows must precisely coordinate different work procedures that must also coordinate the competency and specialties of the individual specialists.

Due to high operating and personnel costs, an effective process workflow composed of multiple individual work processes is particularly important for medical diagnostics. For example, the primary activity of a radiologist concerns the appraisal and evaluation of radiological image exposures. All further activities, such as the preparation of a presentation of a patient finding in a clinical conference with medical specialists, lie outside of this actual primary focus activity and thus reduce the effectiveness of workflows at a radiological station. Since the requirements for a presentation, moreover, can differ significantly depending on the type and requirements of the panel receiving the presentation, a competent radiologist must first learn the specific requirements for the presentation to the respective panel and then (in part) manually determine, and possibly prepare and compose, the necessary documents for the presentation in a very time-consuming manner.

Methods for supporting the workflows for data preparation of patient findings are known in the art. DE 101 25 504 B4 discloses a method for workflow management of diagnostic workflows at a number of computerized diagnostic and processing workstations. As disclosed therein, after the input and classification of medical image data, a template is associated with the image data dependent on the classification, the template establishing the respective processing of the image data in one or more processing steps and generating a corresponding job file with data for identification of the individual processing steps. The processing steps can be implemented by different processors at different computerized workstations, so the method coordinates and monitors the individual workstations so as to build on one another.

This known method has the disadvantage that the operators at the respective workstations receive no further support for his or her diagnostic work and, given difficult or complex patient findings, the operator/diagnostician must coordinate, conscript and (in part manually) determine and compose the medical data to be examined in the conference in the form of a data set.

### SUMMARY OF THE INVENTION

An object of the present invention is to unburden medical specialist personnel in the composition of relevant medical data for a presentation of the medical data in the framework of a medical panel presentation.

The object is achieved in accordance with the invention by a computerized method for compilation of a medical data set for presentation to at least one panel of medical practitioners, such as medical specialists wherein after classification of a finding in a patient record as being relevant for the presentation, relevant rules are determined (selected) from an existing rule base and the relevant rules are composed into a relevant rule set dependent on the relevant entries in the patient record or relevant conditions for the composition of the medical data set. The relevant rule set in determined in this manner is subsequently applied to the entries in the patient record and the medical data set is extracted from the entries of the patient record on the basis of the relevant rule set, thereby composing the medical data set necessary for the presentation. After the composition of the medical data set, the medical data set is communicated to the panel or a reference (in particular a “link”) to the data set is stored via which the panel can access the data set.

Entries of a patient record in the sense of the invention are all data for the diagnostic, therapeutic and organizational support of a particular patient as well as the economic costs associated therewith, such as, for example, findings, incompatibilities, therapy plans, medical images, admission to a hospital, daily costs, current, electronically-detected position of the patient, age of the patient, type of health insurance or desires of the patient during his or her hospital residence.

All necessary data extracted from the entries of the patient record (such as, for example, medical images, incompatibilities) for the respective presentation to a medical panel are designated as a medical data set in the sense of the present invention.

All meetings and pollings of medical specialists with regard to the assessment of medical facts are understood as a panel. The panel can be assembled within a hospital, within a network of medical specialists, or in the framework of a scientific presentation such as a medical congress.

The invention enables an effective workflow for the initiation and the preparation of the presentation of a patient finding to a medical panel, the workflow being focused on the respective operating field of the medical specialists. The workflows of the processor, in particular of the diagnostically active radiologist, are not adversely affected by the automatic generation of the presentation documents, and simultaneously ensure a high quality standard for the presentation, by the continuous fulfillment of the presentation standards for the medical data set generated by the relevant rule set. The operator is thereby freed from the task of composing the medical data sets and can concentrate on his or her primary diagnostic task. The usage of the existing and relevant rule base ensures that various differing requirements for the medical data sets and their presentations are also taken into account, even for varying panels. The inventive method enables an automated composition of even highly different patient data into a medical data set for presentation to a panel, such that the radiologist entrusted with the diagnosis can concentrate on the actual workflows of the diagnosis, while effective workflows outside of the diagnosis are simultaneously ensured.

In one embodiment of the computerized method, the classification of the finding as relevant for the presentation is done by the operator, or automatically through a computer-aided query of relevant entries of the patient file (patient record). It is thus ensured that the initiation of the inventive method is possible either based on the current necessity of the presentation of a patient finding within a selected panel, or presentations at regular intervals can be provided for the responsible panel based on determined workflows within a diagnostic department.

An advantage is that every rule of the present rule set is defined by an association between necessary conditions for the respective rule, and method steps are defined with these by conditions. By the use of a simple rule design in the sense of a classical “IF-THEN” association, it is possible to form complex rule circumstances with simple rules. The rules can hereby be generated via a computer system based on current circumstances or be generated simply and quickly by an operator.

In another embodiment of the computerized method, the rule set is generated by the operator, or automatically through a computer-aided query while taking into account the entries of the patient file, with the availability of the medical specialists, the requirements of the medical data set for the presentation, the infrastructure of a hospital and/or the infrastructure of a medical department being associated with the patient file. For example, the existing rule base can be generated by a computer system on the basis of the current presence of medical specialists or based on the capacities of the medical panel, and can be used as a basis for the automated composition process of the medical data sets. In connection with the simple rule syntax of the respective rules, the existing (and thus relevant) rule base can be generated very simply by an operator or by a computer system under consideration of the current requirements and conditions for the presentation to the panel.

Every rule of the existing rule base is applied to all or selected entries of the patient file classified as being relevant so that upon the fulfillment of the necessary condition of a rule by at least one entry in the patient record, this rule is classified by means of a positive Boolean value and this rule is thereby defined as part of the relevant rule set. The fulfillment criterion of each rule is advantageously characterized with “TRUE” or “FALSE”, such that the rules characterized as “TRUE” can be generated as relevant and so can be collected a relevant rule set. The rule syntax is advantageously provided by the Boolean variable of a rule being altered as part of the rule for the particular case of the established relevance.

The medical data set formed by means of the relevant rule set preferably is checked with regard to the requirements for the presentation and is supplemented if necessary. Through a suitable plausibility check it is ensured that the requirements for the presentation of the already-generated medical data set are always satisfied, in the event of the rule set being incomplete and/or insufficiently relevant. For example, a specification of the residence of the patient may be necessary as a requirement for the presentation to a specific panel, but this may not have been ensured by a rule in the existing rule base and/or in the relevant rule set. Through a final plausibility check as to whether the medical data set generated by the relevant rule set has satisfied all specific requirements for the presentation to a particular panel, medical data set can be supplemented to address the absence of a necessary specification in the medical data set, so a consistently high quality standard of the generated medical data sets can be ensured for the presentations.

At least two medical data sets are advantageously merged into a presentation, and thus the presentation as well as the assessment of multiple medical data sets are efficiently enabled for the medical personnel who will be present at a meeting date of the panel.

The present invention can be realized in the form of hardware, software or a combination of hardware and software. Any type of rule-based computer system or other computational device set up for execution of the inventive method is suitable. A typical combination of hardware and software could be a universal computer system with a computer program that is loaded into the universal computer system to execute and control the computer system to implement the rule-based method described here. The present invention can also be integrated into a computer program product which comprises all features that enable it to realize the computer-aided method described here and which is in the position to execute this method after the loading into a computer system.

As used herein, “computer program” means any expression, in any computer language, code or notation, of a set of instructions that enables a computer system to process data and thus to execute a specific function. The computer program can be run on the computer system either directly or after a conversion into another language, code, notation or via a presentation in another material form.

### DESCRIPTION OF THE DRAWINGS

FIG. 1 is a flow chart of the basic steps of an embodiment of the inventive method.

FIG. 2 is a block diagram that schematically illustrates the generation of a rule according to the inventive method.

FIG. 3 illustrates an advantageous rule syntax of the inventive method.

### DESCRIPTION OF THE PREFERRED EMBODIMENTS

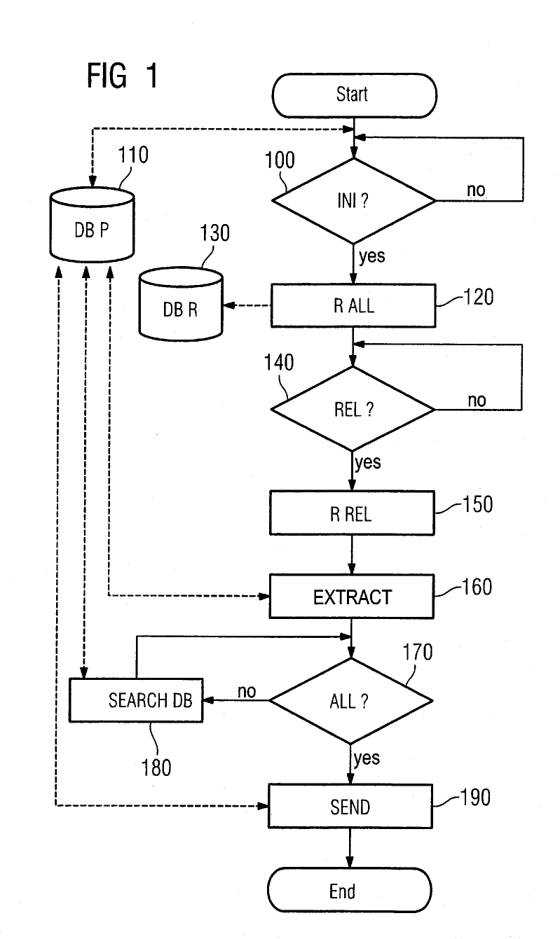

Figure FIG. 1 shows a flow chart of an embodiment of the inventive method. After the initiation of the method, in a comparison operation 100 it is checked whether a patient file 110a (not shown) or a partial data set thereof that is present in the patient databank 110 is to be classified as relevant for a presentation to a panel. This can ensue either via an automatic query of all patient files 11a in the patient databank 110. The method is continued for this patient file 11a only given the fulfillment of specific conditions for a patient record 110a. The classification of the patient record 110a as relevant for the presentation can likewise be effected by a processor. In this case the comparison operation 100 already runs through the further method given the presence of a corresponding classification decision and no loop with the comparison operator 100 (as illustrated in FIG. 1) is necessary.

The existing rule base is subsequently extracted from a rule base databank 130. This can ensue by means of an automatic access to the rule base databank 130 with automatic further processing, or the present rule base can be generated by an operator (for example by means of pull-down menus on a graphical user interface). Each rule 130a (not shown) of the of the present rule set is then checked with a comparison operation against the selected patient file 110a with regard to its relevance for the selected patient file 110a. In the case of a detected relevant rule 130a, this is associated with a relevant rule set via an association process 150. The relevant rule set is subsequently applied to the data of the patient file 110a and the relevant data of the patient file 110a are extracted in step 150, and are read out from the patient databank 110 or are made accessible via referencing.

A concluding plausibility check 170 ensures that all data composed via the relevant rule set correspond to the requirements of the medical data set 200 (not shown) to be presented. In the event that this is not ensured, the still-missing data in the medical data set 200 are determined from the patient databank 110 via a supplemental operation 180 and are added to the medical data set 200. It is possible, for example, that the listing of the previous treating physicians of the patient is viewed as a necessary presentation condition for the presentation to a particular panel. If this requirement was not implemented in the present or relevant rule set, it is ensured through the concluding plausibility check that the presentation requirements established for each panel are fulfilled by the medical data set 200. The medical data set 200 composed in this manner is subsequently communicated in step 190 to the panel. The medical data set 200 can either be directly sent to all previously-determined members of the panel or be stored on a provided server and be automatically retrieved and presented to the panel as needed or on the scheduled presentation date.

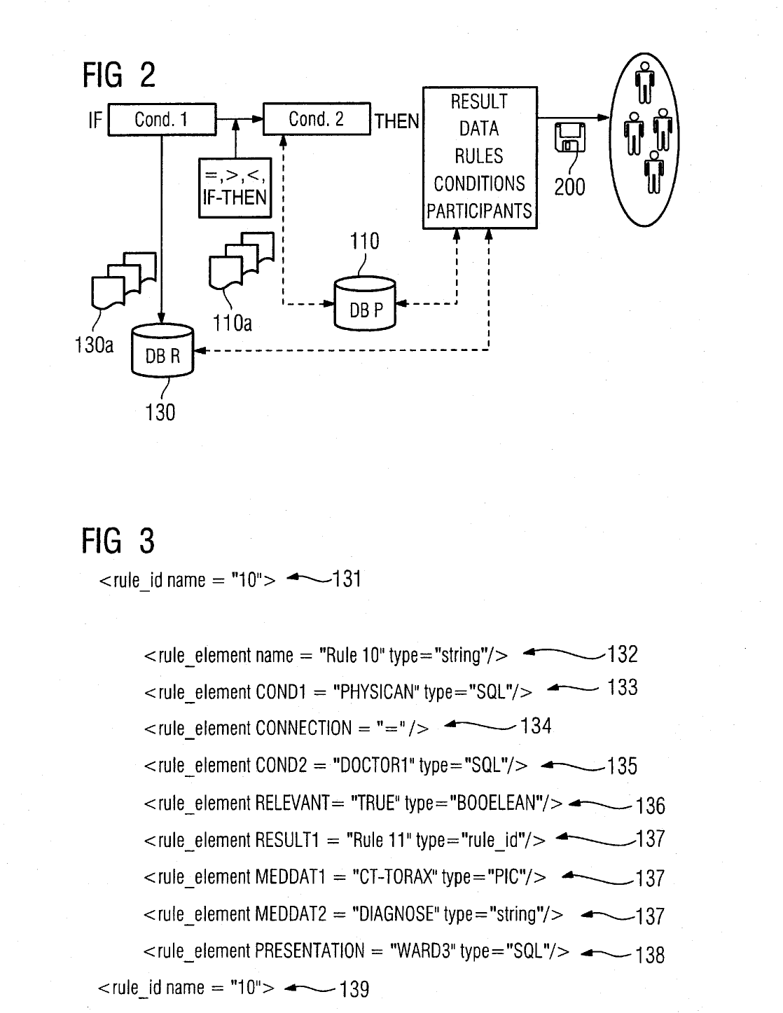

An exemplary rule structure according to the inventive method can be seen from FIG. 2. The basic structure of an “IF-THAN” instruction includes two basic operators for the necessary conditions of the respective rule (designated as COND.1 and COND.2 in FIG. 2) and two result operators for the events linked with the necessary conditions and the necessary information for the sending of the medical data set 200 to the corresponding panel.

The necessary conditions can be retrieved and selected, for example, as pull-down menus on a graphical user interface. This graphical editing function can be used in the generation of the present rule set; for the generation of the relevant rule set; for the application of the relevant rule set for extraction of the relevant entries from the patient file 110a; and/or for the classification of a patient file 110a as relevant for a presentation.

FIG. 2 shows an exemplary generation of a rule in accordance with the inventive method. A processor can select the necessary fields (such as, for example, COND.1 or COND.2) by means of a graphical user interface. For this purpose, the respective fields are connected with a wide range of different databanks such as, for example, the patient databank 110 or the rule databank 130. The participation of specific medical specialists in the framework of a field selection can likewise be taken into account. For example, the presenters in the panel can be selected as a first necessary condition (COND.1) for the current rules to be generated. The currently present physicians can be selected as a second necessary condition (COND.2). Given the selection of a specific physician (for example “leading senior physician”) as COND.2, it is defined as a result that the composed medical data set 200 is to be archived given the selection “leading senior physician” for the case of a private insurance of the patient treated by the leading senior physician and given an age of the patient over 60 years. At the same time the medical data set 200 is to be presented to the panel “computer tomography” in this case. The presentation requirements for the panel “computer tomography” are the presentation of the previous CT exposures of the patient in connection with the tabular listing of the previous documented course of illness of the patient.

Upon the completion of the rules, the computer system determines all necessary links and storage locations of the data necessary for satisfaction of the rule 130a and connects this storage address with the respective rule 130a. With this rule 130 generated in such a manner, it is possible for the rule-based system to independently generate the necessary data for the presentation of the respective medical data set 200 and to therewith automatically compose the presentation documents.

The listing in FIG. 3 exemplarily illustrates a rule specifications according to the inventive method. The rule syntax for general presentation follows (conforms to) the programming language C, this rule syntax merely being selected for exemplary presentation and does not represent a limitation to this rule structure. Rather, the rule 130a can be defined as a set of instructions in any arbitrary computer language, code or in any machine-readable form.

With the initiation 131 of the respective rule 130a, the respective rule comprises an introductory name association 132. The necessary conditions 133, 134 of the rule 130a are subsequently read out from a databank 110, 130 in SQL format and are connected with one another with a selectable link 134. The rule 130a also includes a Boolean variable that indicates the relevance 136 of the respective rule for a patient file 110a. The Boolean variable of this rule 130a can hereby be set to “TRUE” in the event of a relevance and thus be selected as a portion of the relevant rule set given a subsequent retrieval of this rule 130a. The events connected with the necessary conditions 133, 134, 135 of this rule 130a are stored in the rule elements 137. The rule 130a also includes continuative information instructions 138 of the appertaining panel.

Although modifications and changes may be suggested by those skilled in the art, it is the intention of the inventor to embody within the patent warranted hereon all changes and modifications as reasonably and properly come within the scope of his contribution to the art.

I claim as my invention:

1. A computerized method for compiling medical data sets for presentation to a panel of medical practitioners, comprising the steps of:
classifying at least one data entry in a patient file as being relevant for a specific presentation to medical practitioners, thereby identifying at least one relevant data entry in said patient file;
automatically electronically determining relevant rules from an existing rule base, dependent on said at least one relevant entry or on relevant conditions for composing a medical data set, and combining said relevant rules into a relevant rule set;
automatically electronically applying said relevant rule set to said at least one selected entry from said patient file; and
automatically electronically extracting said medical data set from said patient file using said relevant rule set to obtain a composition of said medical data set that is necessary for said presentation; and
making said medical data set available for said presentation.

2. A computerized method as claimed in claim 1 comprising, at a computer, making a computerized menu of said data entries in said patient file available at a user interface and, via said user interface, allowing an operator to identify said at least one relevant entry using said menu.

3. A computerized method as claimed in claim 1 comprising automatically electronically identifying said at least one relevant entry in a computer.

4. A computerized method as claimed in claim 1 comprising automatically electronically determining said relevant rules from said existing rule base by defining an association between at least one of said at least one relevant entry or said relevant conditions, and each rule in said existing rule base.

5. A computerized method as claimed in claim 1 comprising determining said relevant rules from said existing rule base dependent on relevant conditions from the group consisting of availability of members of said panel, requirements associated with said presentation of said medical data set, a hospital infrastructure for a hospital treating a patient having said patient file, and a medical department infrastructure of a medical department treating a patient having said patient file.

6. A computerized method as claimed in claim 1 comprising determining said relevant rules from said existing rule base by applying respective rules in said existing rule base to said at least one entry in said patient file, and classifying an applied rule as being a relevant rule upon fulfillment of a necessary condition designated by an entry in said patient file, and then classifying the rule as being relevant by assigning a positive Boolean value to the relevant rule.

7. A computerized method as claimed in claim 1 comprising, after extracting said medical data set and before presentation of said medical data set, checking said medical data set with respect to requirements for said presentation and, if necessary, supplementing said medical data set to satisfy said requirements.

8. A computerized method as claimed in claim 1 wherein said medical data set is a first medical data set and wherein said at least one data entry is a first data entry, and said relevant conditions are first relevant conditions, and generating a second data set with at least one second data entry, different from said first data entry, or at least one second relevant condition, different from said first relevant conditions, and combining said first medical data set and said second medical data set to form a combined medical data set, and making said combined medical data set available for said presentation.

9. A computerized method as claimed in claim 1 comprising storing said medical data set, as a stored medical data set, and making said stored medical data set available for said presentation by providing respective medical practitioners in said panel with access to the stored medical data set.

10. An arrangement for compiling medical data sets for presentation to a panel of medical practitioners, comprising:
a computer having a user interface allowing manual classification of at least one data entry in a patient file as being relevant for a specific presentation to medical practitioners, thereby identifying at least one relevant data entry in said patient file;
a data bank accessible by said computer, said data bank containing a rule base comprising rules for composing medical sets for different presentations;
said computer automatically determining relevant rules from said rule base, dependent on said at least one relevant entry or on relevant conditions for composing a medical data set, and combining said relevant rules into a relevant rule set, and said computer automatically applying said relevant rule set to said at least one selected entry from said patient file, and automatically extracting said medical data set from said patient file using said relevant rule set to obtain a composition of said medical data set that is necessary for said presentation, and making said medical data set available for said presentation.

11. A computer-readable medium encoded with a data structure for compiling medical data sets for presentation to a panel of medical practitioners, said data structure, when said medium is loaded into a computer, causing said computer to
classify at least one data entry in a patient file as being relevant for a specific presentation to medical practitioners, thereby identifying at least one relevant data entry in said patient file;
determine relevant rules from an existing rule base, dependent on said at least one relevant entry or on relevant conditions for composing a medical data set, and combine said relevant rules into a relevant rule set;
apply said relevant rule set to said at least one selected entry from said patient file;
extract said medical data set from said patient file using said relevant rule set to obtain a composition of said medical data set that is necessary for said presentation; and
make said medical data set available for said presentation.
